(19) United States
(12) Patent Application Publication
(10) Pub. No.: US 2014/0062026 A1
(43) Pub. Date: Mar. 6, 2014

(54) FACE SEAL RETAINING ASSEMBLY FOR GAS TURBINE ENGINE

(71) Applicants: Todd A. Davis, Tolland, CT (US); William G. Sheridan, Southington, CT (US)

(72) Inventors: Todd A. Davis, Tolland, CT (US); William G. Sheridan, Southington, CT (US)

(21) Appl. No.: 13/598,702

(22) Filed: Aug. 30, 2012

(51) Int. Cl. F16J 15/34; B23P 6/00

(52) U.S. Cl. 277/358; 29/402.01

(57) ABSTRACT

A face seal assembly for a gas turbine engine includes an engine static structure. A guide assembly supports a face seal for movement relative to the engine static structure in an axial direction. The guide assembly includes a guide pin having a first end that supports a washer that is retained by a circlip secured to the first end. The circlip is configured to limit movement of the face seal in the axial direction.

### BACKGROUND

This disclosure relates to a gas turbine engine face seal retaining assembly.

Conventional mechanical face seals are used in rotating equipment, such as gas turbine engines, to provide a fluid seal between regions of high and low fluid pressure. For example, mechanical face seals are used for sealing a rotating shaft on a pump, compressor, agitator, gas turbine, or other rotating equipment. In gas turbine engines, mechanical face seals are used to prevent hot, high pressure air from entering a bearing compartment that operates at a lower pressure and temperature.

A conventional metal-backed face seal arrangement for a gas turbine engine includes an annular graphitic carbon seal secured to a rotationally static, axially translatable, annular metal seal housing. A seal seat is affixed to a rotatable engine main shaft and positioned axially adjacent to the graphitic carbon ring. A nose of the annular graphitic carbon seal is urged into contact with the seal seat by a combination of spring forces acting on the seal housing and the net resultant of axially opposing fluid pressure forces. The contact between the nose and the seal seat resists fluid leakage across the seal arrangement in the radial direction.

Typically, a conventional graphitic carbon mechanical face seal arrangement includes multiple guides affixed to a non-rotatable support or seal housing. The seal housing axially translates along the spring guides. Coil springs provide a bias force that urges the graphitic carbon into contact with the seal seat.

Typically, face seal assemblies use bent cotter pins to retain a cap onto a guide pin, which limits seal axial travel. This cotter pin is required to be bent during installation to prevent it from liberating during engine operation. As the guide pin straightness is critical to seal performance, bending the cotter pin incorrectly can result in seal performance issues. Also the bent cotter pin is a one-time use part, and may present a foreign object debris risk.

### SUMMARY

In one exemplary embodiment, a face seal assembly for a gas turbine engine includes an engine static structure. A guide assembly supports a face seal for movement relative to the engine static structure in an axial direction. The guide assembly includes a guide pin having a first end that supports a washer that is retained by a circlip secured to the first end. The circlip is configured to limit movement of the face seal in the axial direction.

In a further embodiment of any of the above, the guide pin includes a second end secured to the static structure. The axial direction is defined between the first and second ends.

In a further embodiment of any of the above, the face seal includes a carrier slideable relative to the guide pins.

In a further embodiment of any of the above, the face seal includes an annular metal backed carbon seal.

In a further embodiment of any of the above, the face seal assembly includes a rotating structure that is supported relative to the engine static structure by a bearing. A seal seat is mounted on the rotating structure.

In a further embodiment of any of the above, the guide assembly includes a guide provided by a carrier, with the guide pin received in the guide.

In a further embodiment of any of the above, the guide assembly includes a sleeve mounted on the guide pin and is in sliding engagement with the guide.

In a further embodiment of any of the above, the washer abuts the sleeve.

In a further embodiment of any of the above, the guide pin includes a shoulder. The washer abuts the shoulder.

In a further embodiment of any of the above, the face seal assembly includes an annular recess in the first end adjacent to the washer that receives the circlip.

In a further embodiment of any of the above, the face seal assembly includes a spring arranged between the face seal and the engine static structure to bias the face seal away from the engine static structure.

In a further embodiment of any of the above, the face seal assembly includes multiple guide assemblies spaced circumferentially about the face seal.

In a further embodiment of any of the above, the first end includes a tapered surface near the circlip.

In another exemplary embodiment, a method of servicing a face seal assembly includes the steps of installing a carrier having a face seal onto a guide assembly mounted on a support wall, and installing a circlip onto the guide assembly to retain the carrier.

In a further embodiment of any of the above, the guide assembly includes a guide pin secured to the support wall, and comprising installing a sleeve onto the guide pin and into an aperture of the carrier before the circlip installing step.

In a further embodiment of any of the above, the method includes the step of installing a washer onto the guide pin before the circlip installing step. The circlip abuts the washer.

In another exemplary embodiment, a method of servicing a face seal assembly includes the steps of removing a circlip from a guide assembly, and removing a carrier having a face seal relative to the guide assembly.

In a further embodiment of any of the above, the method includes the step of removing a washer after the circlip removing step.

### BRIEF DESCRIPTION OF THE DRAWINGS

The disclosure can be further understood by reference to the following detailed description when considered in connection with the accompanying drawings wherein:

FIG. 1 is a schematic view of a portion of a gas turbine engine including a face seal assembly.

FIG. 2 is a schematic view of a face seal assembly illustrating multiple circumferentially spaced guide assemblies.

FIG. 3 is an enlarged perspective view of an example guide assembly.

FIG. 4 is a cross-sectional view of the guide assembly illustrated in FIG. 3.

### DETAILED DESCRIPTION

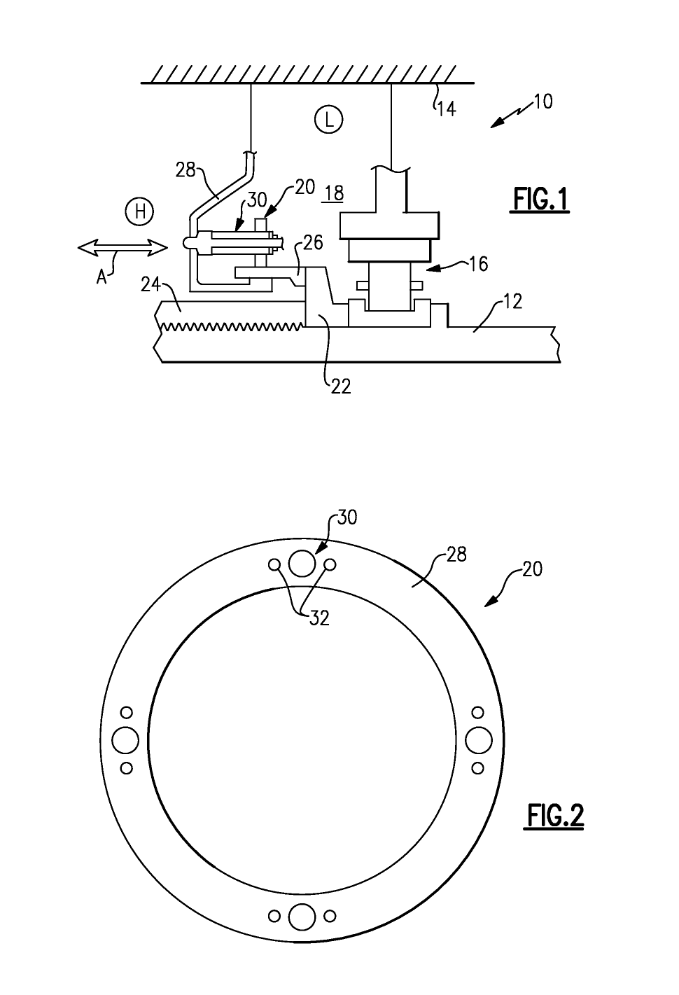

A gas turbine engine 10 is schematically illustrated in FIG. 1. The engine 10 includes a rotating structure, which includes a shaft 12. The shaft 12 is supported for rotation relative to an engine static structure 14 by a bearing 16. The bearing 16 is arranged in a bearing compartment 18, which is sealed by a face seal assembly 20 that separates high and low pressure regions of the engine 10.

The face seal assembly 20 includes a seal seat 22, which is supported by the rotating structure, in the example, the shaft 12. The seal seat 22 is secured to the shaft 12 by a nut 24 in the example. The face seal assembly 20 includes a face seal 26 that is biased into engagement with the seal seat 22 to seal the bearing compartment 18. In one example, the face seal 26 is provided by a annular metal backed carbon seal.

The face seal assembly 20 includes a support wall 28 fixed relative to the engine static structure 14. A guide assembly 30 supports the face seal 26 for translational movement relative to the engine static structure 14 in an axial direction A. As illustrated in FIG. 2, multiple guide assemblies 30 are spaced circumferentially about the support wall 28 to support the annular face seal 26. Biasing members 32 are provided on either side of each guide assembly 30, as best illustrated in FIG. 3. The biasing members 32 include helical springs 42 provided on either side of the guide 36 and engagement with the support wall 28 and the carrier 34.

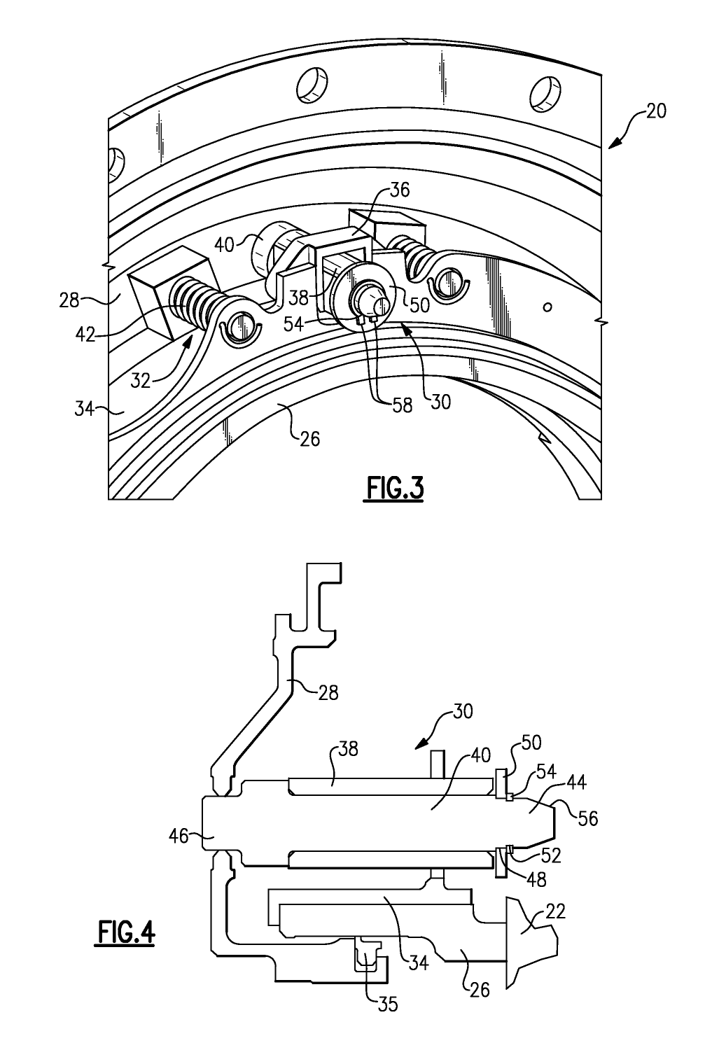

A carrier 34 supports the face seal 26. The guide assembly 30 provides precise sliding movement between the guide assembly 30 and the carrier 34. In the example, the guide assembly 30 includes a guide 36 having an aperture that is provided by the carrier 34. A guide sleeve 38 is mounted on a guide pin 40 mounted to the support wall 28. The guide pin 40 includes spaced apart first and second ends 44, 46. The second end 46 is mounted to the support wall 28, as best shown in FIG. 4. In the example, the guide 36 provides a rectangular aperture, and the guide sleeve 38 includes opposing flat surfaces configured for sliding engagement with opposing sides of the aperture.

With reference to FIG. 4, the first end 44 includes a shoulder 48. A washer 50 is mounted on the first end 44 and is arranged in abutment with the shoulder 48 adjacent to one end of the guide sleeve 38. An annular recess 52 is provided in the first end 44 adjacent to the washer 50. The annular recess 52 receives a circlip 54 adjacent to the washer 50. The circlip 54 is configured to limit movement of the face seal 26 so that the face seal 26 is not overextended during assembly.

An annular seal 35 is provided between the carrier 26 and the support member 28.

The first end 44 may include a conical surface 56 to facilitate installation of the circlip 54 into the annular recess 52. In the example, the circlip 54 is an external circlip having opposing ears 58 that are used for installation and removal with circlip pliers, for example.

During assembly of the face seal assembly 20, the carrier 34 is mounted onto the support wall 28 with the guide pins 40 received in the apertures of the guides 36. The guide sleeves 38 are slid onto the guide pins 40 such that the flat opposing surfaces of the guide sleeves 38 mate with the corresponding flats of the aperture of the guide 36. The washer 50 is received by the first end 44, and the circlip 54 is slid over the conical surface 56 and seated within the annular recess 54.

To service the guide assembly 30, the circlip 54 is removed using circlip pliers. The washer 50 is removed from the first end 44. With the washer 50 removed, the guide sleeve 38 and/or the carrier 34 may be removed from the support wall 28.

Although an example embodiment has been disclosed, a worker of ordinary skill in this art would recognize that certain modifications would come within the scope of the claims. For that reason, the following claims should be studied to determine their true scope and content.

What is claimed is:

1. A face seal assembly for a gas turbine engine comprising:
an engine static structure; and
a guide assembly supporting a face seal for movement relative to the engine static structure in an axial direction, the guide assembly including a guide pin having a first end supporting a washer that is retained by a circlip secured to the first end, the circlip configured to limit movement of the face seal in the axial direction.

2. The face seal assembly according to claim 1, wherein the guide pin includes a second end secured to the static structure, the axial direction is defined between the first and second ends.

3. The face seal assembly according to claim 1, wherein the face seal includes a carrier slideable relative to the guide pins.

4. The face seal assembly according to claim 1, wherein the face seal includes an annular metal backed carbon seal.

5. The face seal assembly according to claim 1, comprising a rotating structure supported relative to the engine static structure by a bearing, and a seal seat mounted on the rotating structure.

6. The face seal assembly according to claim 1, wherein the guide assembly includes a guide provided by a carrier, with the guide pin received in the guide.

7. The face seal assembly according to claim 1, wherein the guide assembly includes a sleeve mounted on the guide pin and in sliding engagement with the guide.

8. The face seal assembly according to claim 7, wherein the washer abuts the sleeve.

9. The face seal assembly according to claim 8, wherein the guide pin includes a shoulder, the washer abutting the shoulder.

10. The face seal assembly according to claim 8, comprising an annular recess in the first end adjacent to the washer that receives the circlip.

11. The face seal assembly according to claim 1, comprising a spring arranged between the face seal and the engine static structure to bias the face seal away from the engine static structure.

12. The face seal assembly according to claim 1, comprising multiple guide assemblies spaced circumferentially about the face seal.

13. The face seal assembly according to claim 1, wherein the first end includes a tapered surface near the circlip.

14. A method of servicing a face seal assembly comprising the steps of:
installing a carrier having a face seal onto a guide assembly mounted on a support wall; and
installing a circlip onto the guide assembly to retain the carrier.

15. The method according to claim 14, wherein the guide assembly includes a guide pin secured to the support wall, and comprising installing a sleeve onto the guide pin and into an aperture of the carrier before the circlip installing step.

16. The method according to claim 15, comprising the step of installing a washer onto the guide pin before the circlip installing step, the circlip abutting the washer.

17. A method of servicing a face seal assembly comprising the steps of:
removing a circlip from a guide assembly; and
removing a carrier having a face seal relative to the guide assembly.

18. The method according to claim 17, comprising the step of removing a washer after the circlip removing step.
